(19) United States
(12) Patent Application Publication
(10) Pub. No.: US 2025/0376206 A1
(43) Pub. Date: Dec. 11, 2025

(54) Mechanism for Manually Actuating the Simultaneous and Symmetrical Inboard Motion of Opposing Members

(71) Applicant: Harper Trucks, Inc., Wichita, KS (US)

(72) Inventor: Jose' Angel Caceres Mendoza, Wichita, KS (US)

(73) Assignee: Harper Trucks, Inc., Wichita, KS (US)

(21) Appl. No.: 19/220,493

(22) Filed: May 28, 2025

Related U.S. Application Data
(60) Provisional application No. 63/658,770, filed on Jun. 11, 2024.

(51) Int. Cl. B62B 5/06

(52) U.S. Cl. CPC B62B 5/064

(57) ABSTRACT

A mechanism for manually actuating the symmetrical and simultaneously inward translation of spaced apart members which may be connected to a two sided locking system includes a housing that slidably houses a push member and two opposite shuttles which are at least indirectly connected to the spaced apart members. The push member and the shuttles present to each other inwardly sloped corresponding surfaces so that when the push member is pushed with manual pressure, the inwardly sloped surfaces of the push member engage the correspondingly inwardly sloped surfaces of the shuttles so that the shuttles move inwardly in a simultaneous and symmetrical manner thereby causing the members to move toward each other in a simultaneous and symmetrical manner.

### RELATED APPLICATIONS

This application claims the benefit of U.S. Provisional Patent Application No. 63/658,770 which was titled Mechanism for a Four Position Hand Truck which was filed on 11 Jun. 2024 which is incorporated herein by reference as if repeated hereinafter.

### FIELD

This application relates to a mechanism which is able to pull two outwardly biased symmetrical opposite pins inwardly in a symmetrical fashion when a single push member of the mechanism is pushed with manual force from a first outward position to a second inward position.

### BACKGROUND

The multi-position hand truck that is described and shown in U.S. Pat. No. 10,864,933 which is incorporated herein by reference. U.S. Pat. No. 10,864,933 teaches a mechanism that includes two spaced apart rods which are able to be manually urged toward each other. The manual urging together action causes locks or locking pins to which the rods are attached on each side of the mechanism to be released from locking engagement, which, in turn, allows the rotation of a handle with respect to a hand truck frame and also allows the sliding movement of the handle in relation to the hand truck frame. This makes it possible to quickly change the relationship between the handle and the truck frame so that the hand truck may be configured in various positions as shown and described in U.S. Pat. No. 10,864,933. However, the manual mechanism as shown in FIG. 7 of the referenced patent does require a certain level of dexterity in that both of the rods that are used to actuate the locking mechanism must be pulled so as to cause the same amount of displacement on both sides at the same time. What is needed is a mechanism that can be easily manually manipulated to accomplish symmetrical displacement of the locking mechanism on both sides of the hand truck in a manner that is both symmetrical and simultaneous.

### SUMMARY

The above noted need is addressed by a mechanism that presents to opposite rods that are arranged on a mechanism centerline which may be pulled toward each other with symmetrical movement and displacement. The mechanism includes a housing, a push member, two opposite symmetrical shuttles and two opposite symmetrical rod members. The housing is arranged so that the push member is received and captured by the housing and is constrained to and able to slide along a path that is perpendicular to the centerline of the mechanism between a first outward position and a second inward position. The housing is also arranged to receive the two symmetrical and opposite shuttles. Each shuttle is constrained to and able to slide along a path that is in alignment with the mechanism centerline between a first extended position and a second retracted position. The sliding push member has opposite slots that receive a narrow portion of each shuttle. The sliding push member also has opposite and symmetrical slanted surfaces that slant inwardly. The shuttles extend into the sliding push member and further have portions that present corresponding slanted surfaces which are able to slide along the slanted surfaces of the push member. Thus, when the push member is pushed toward the inward position, the symmetrical slanting surfaces of the push member engage the corresponding symmetrical slanting surfaces of the opposite shuttles to cause the shuttles to move inboard and toward each other. The symmetrical inward motion of the shuttles causes the two opposite rod members to retract toward each other also in a simultaneous and symmetrical fashion. It is also preferable that in a lock release mechanism for unlocking the sliding of a handle and the rotation of a handle of a hand truck, that the rods are biased toward the outboard direction. Thus, unless the push member is depressed with a manual force, the rods and the shuttles will remain in the outboard direction which is needed, in this example, for locking the rotation and the sliding of a handle assembly with respect to the frame of a hand truck. This biasing also biases the push member toward the outward position.

### BRIEF DESCRIPTION OF THE DRAWINGS

FIG. 1 is a perspective view of lock release mechanism shown and described in U.S. Pat. No. 10,864,933 which is incorporated herein by reference.

FIG. 2 is an exploded perspective view of the improved lock release mechanism.

FIG. 3A is an exposed perspective view of the lock release mechanism shown with the upper portion of the housing removed for clarity also showing a push member in an extended or released position.

FIG. 3B is an exposed perspective view of the lock release mechanism as shown in FIG. 3A with the push member removed in order to expose the shuttles.

FIG. 4A is an exposed perspective view of the lock release mechanism shown with the upper portion of the housing removed for clarity also showing a push member in a depressed position.

FIG. 4B is an exposed perspective view of the lock release mechanism as shown in FIG. 4A with the push member removed in order to expose the shuttles.

FIG. 5 is a side view of the lock release mechanism shown with the upper portion of the housing removed and shown with the push member in a released extended position.

FIG. 6 is a top view of the lock release mechanism shown with the upper portion of the housing removed and shown with the push member in a released extended position.

FIG. 7 is a cut away side view of the lock release mechanism in accordance with the section indication shown in FIG. 6 also shown with the upper portion of the housing removed and shown with the push member in a released extended position.

FIG. 8 is a side view of the lock release mechanism shown with the upper portion of the housing removed and shown with the push member in a fully depressed position.

FIG. 9 is a top view of the lock release mechanism shown with the upper portion of the housing removed and shown with the push member in a fully depressed position.

FIG. 10 is a cut away side view of the lock release mechanism in accordance with the section indication shown in FIG. 9 also shown with the upper portion of the housing removed and shown with the push member in a fully depressed position.

### DETAILED DESCRIPTION

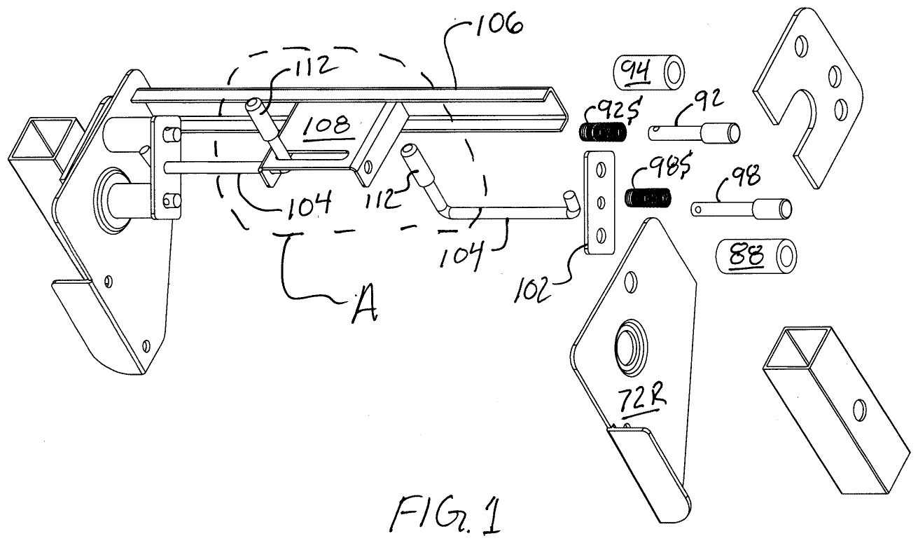

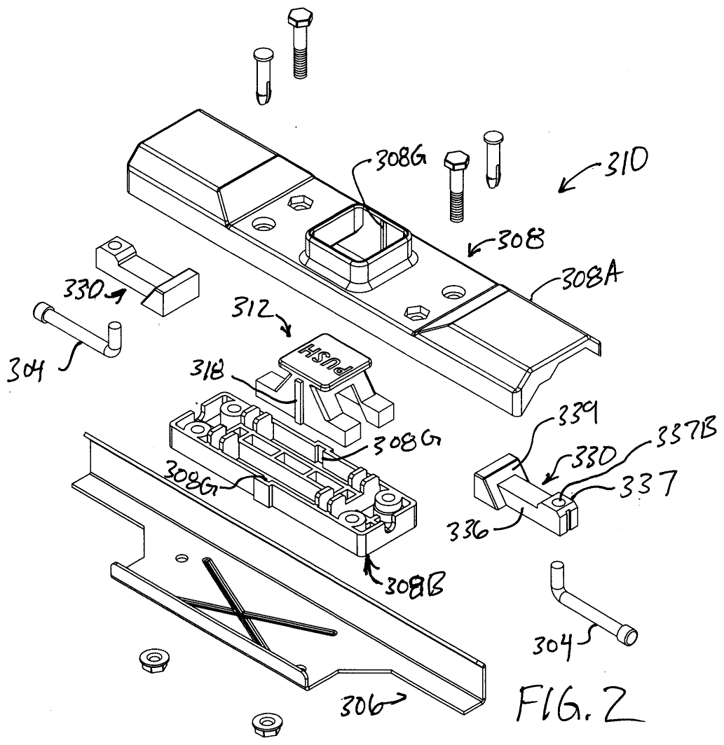

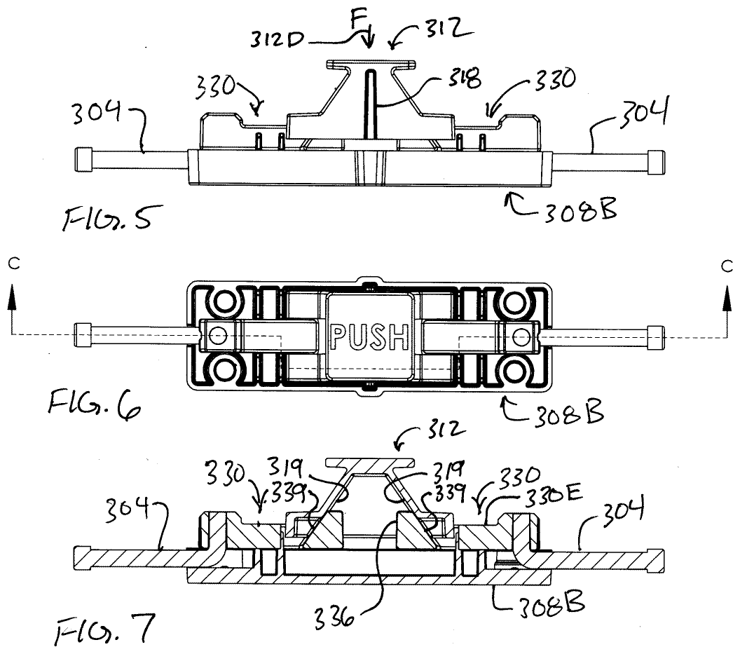

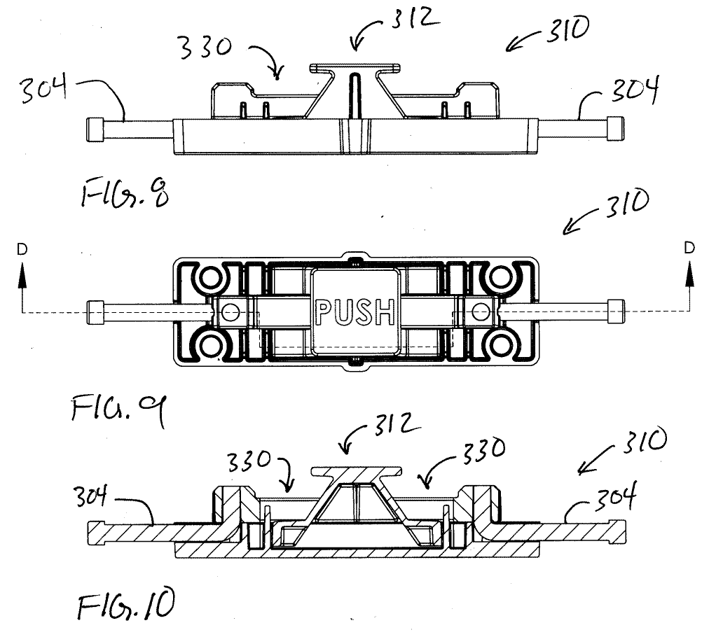

Referring to the drawings, FIG. 1 shows one embodiment of a lock release mechanism as shown and described in U.S. Pat. No. 10,864,933. The skilled reader will notice that symmetrically identical actuator rods 104 are present on opposite sides of the mechanism. Portions 112 are provided for manual manipulation such that portions 112 can be manually urged toward each other so that pins 92 and 98 are pulled inboard. Pins 92 and 98 are biased toward the outward (outboard) and extended position by springs 92S and 98S respectively which are retained within sleeves 94 and 98 which are fixed to backet 72R which is in turn fixed to the frame of a hand truck which is not shown in FIG. 1. Portions 112 may be inwardly urged in order to release a handle assembly (not shown) for one of or both sliding movement and rotating movement. The subject matter of this application is an improved mechanism for causing the controlled inward movement of rods 304 (shown in FIGS. 2-10). Rods 304 are equivalent in function to rods 104 shown in FIG. 1 which is taken, in part from U.S. Pat. No. 10,864,933. The object of this subject matter is to provide an improved mechanism that performs the function of the elements that are encircled by the area indicated as area A in FIG. 1 but does so with greater ease and in a more reliably symmetrical manner.

In the description below, the skilled reader will benefit from understanding directional terms. For this subject matter, an improved mechanism 310 can be understood as having a centerline CL as indicated in FIG. 3A. Movement in a direction that is parallel to centerline CL will be understood as longitudinal movement and if also toward the center of mechanism 310 will also be understood as longitudinal “inboard” movement. Movement in a direction that is parallel to centerline CL which is also away from the center of mechanism 310 will be understood as longitudinal “outboard” movement. Further, movement that is normal or perpendicular to centerline CL will be understood as being transverse movement and will also be understood if also toward the center of mechanism 310 as “transverse inboard” movement and movement that is normal or perpendicular to centerline CL that is also away the center of mechanism 310 will be understood as “transverse outboard” movement.

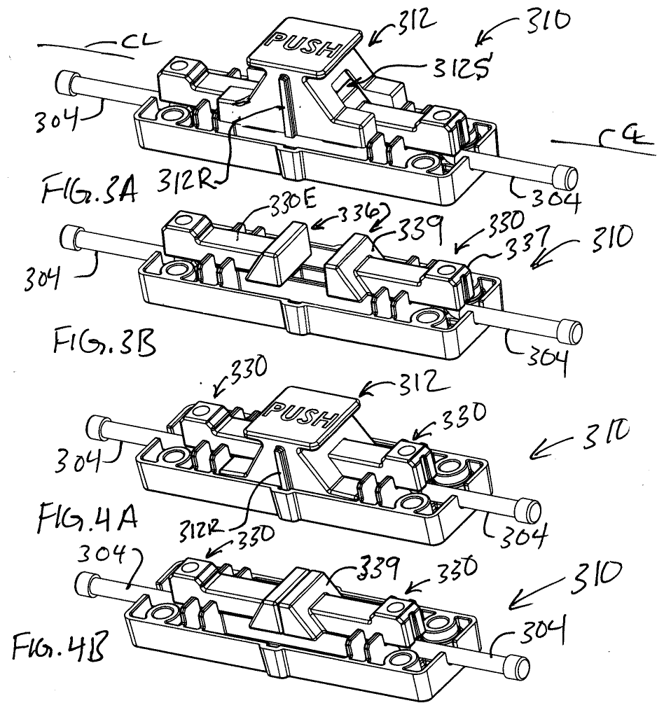

The purpose of improved mechanism 310 is to cause symmetrical, opposite inboard movement of shuttles 330 (and rods 304) from the outboard position shown in FIG. 3B to the inboard position shown in FIG. 4B. Improved mechanism 310 is shown in FIGS. 2-10. FIG. 2 shows and exploded perspective view of mechanism 310 as including a push member 312 that is mounted within a housing 308 as well as two shuttles 330 which are identical in this example and also mounted within housing 308. Shuttles 330 receive rods 304 as can be best seen in FIG. 10. A tray 306 is provided to support improved mechanism 310. A simultaneous and symmetrical inboard movement of shuttles 330 and rods 304 occurs when push member 312 is depressed from the outboard position shown in FIG. 3A to an inboard fully depressed position shown in FIG. 4A. The skilled reader will appreciate that housing 308 may take any form or shape. In this example housing 308 includes two portions, 308A and 308B which, in this example are fastened together by fasteners and supported by tray 306. However, it is essential that housing 308 be adapted to constrain the motion of push member 312 to move between a first outboard position as shown in FIG. 3A and a second inboard position as shown in FIGS. 3B, such movement also being transverse, that is, normal or perpendicular to center line CL shown in FIG. 3A.

In this example, push member 312 presents two opposite ridges 312R, which are received by corresponding grooves 308G in the walls of housing 308 as shown in FIG. 2. These corresponding inter-fitting features, namely, ridges 312R and grooves 308G constrain the above described transverse inboard and transverse outboard movement of push member 312 between the outboard position shown in FIG. 3A and the inboard position shown in FIG. 3B.

FIG. 7 provides a cross-section side view of push member 312. Also shown in FIG. 7 are cross section views of shuttles 330 and rods 304. In this example, shuttles 330 and rods 304 are identical. In FIG. 5, force F indicates the force that is applied to push member 312. Still further, arrow 312D indicates the direction of movement for push member 312 which is perpendicular to the center line CL indicated at the far-left and far-right sides of FIG. 3A. As shown in FIG. 10, push member 312 presents two sets of opposite, symmetrical inside surfaces 319 which slant inwardly, so that when push member 312 is depressed from the position shown in FIG. 7 to the position shown in FIG. 10, the inside surfaces 319 of push member 312 engage the slanted surfaces 339 of shuttles 330. By referring to FIGS. 7 and 10, the skilled reader can see that inside surfaces 319 slant symmetrically inward and converge from the inboard end of push member 312 to its outboard end. Slanted surfaces 339 of shuttles 330 are similarly slanted, however, shuttles 330 cannot move in a transverse direction. Thus, as push member 312 moves in an inboard direction from the extended position shown in FIG. 7 to the depressed position shown in FIG. 10, the converging slanted surfaces 319 of push member 312 slide against the corresponding converging slanted surfaces 339 of shuttles 330 thereby urging shuttles 330 toward each other in a symmetrical fashion.

Shuttles 330 and rods 304 are shown in greater detail in FIGS. 2, 3B and 7. The skilled reader can see that shuttle 330 presents a bore at one end for receiving a right-angled portion of rod 304. Shuttle 330 includes an elongated portion 330E which preferably has a uniform cross section extends between the bore and a head portion 336. Each head portion 336 presents a slanted surface 339. Slanted surface 339 of each shuttle 330 correspond to and match each of the slanted surfaces 319 of push member 312 as noted above. As can be best seen in FIG. 2, for each shuttle 330, opposite head portion 336 on the other end of elongated portion 330E is a foot portion 337. Each foot portion 337 presents a bore 337B which is adapted to receive an inboard upturned portion of rod 304. The elongated portion of each shuttle 330 is received for sliding motion by features in housing 308 so that each shuttle 330 is constrained by housing 308 to move along a longitudinal path that is parallel to center line CL (shown in FIG. 3A). The outward movement of shuttles 330 may be limited by features in housing 308 or by push member 312. As can be best seen in FIG. 3A, elongated portions of shuttles 330 are also received by opposite slots 312S of push member 312. The skilled reader will appreciate that portions 308A and 308B of housing 308, push member 312 and shuttles 330 are preferably fashioned from injection molded plastic. Rods 304 are preferably fashioned from a metal. Tray 306 may be sheet metal or plastic.

The operation of mechanism can be understood by referring to FIG. 3. Recall that on both sides a shuttle 330 and a rod 304 is present. Recall also, that housing 308 is arranged so that both sets of shuttles and rods 330 and 304 are able to move within their desired range of motion between and extended position as shown in FIG. 3A to a retracted position which place the inboard surfaces of shuttles 330 close to the vertical centerline of push member 312 as shown in FIG. 3B. Recall further, that housing 308 is also arranged such that push member 312 when pushed with force F will move in the direction indicated by arrow 312D. As this takes place, the inwardly slanted surfaces 319 of push member will push against the corresponding slanted surfaces 339 of shuttles 330. This will cause shuttles 330 to slide inwardly and retract and this will pull the outwardly biased rods 304 toward each other. This mechanism then, will cause rods 304 to move inwardly in a manner that is both symmetrical and equal.

The skilled reader, who is acquainted with the interfacing mechanisms for locking and unlocking sliding and rotating movement of a handle assembly in a hand truck as shown and described in U.S. Pat. No. 10,864,933, will recall that pins 304 are analogous to pins 104 of U.S. Pat. No. 10,864,933 and are therefore biased in the outboard direction in relation to improved mechanism 310. Accordingly, pins 304 are understood to be biased in the longitudinal outboard direction and push member 312 is understood to also be biased in the transverse outboard direction.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A hand truck comprising:
a frame which extends between a first end and a second end, the frame having main wheels rotatably mounted toward the first end,
a handle assembly including two handle side members, a top member extending between the side members at the upper ends thereof and a caster wheel assembly having spaced apart caster wheels mounted to the lower ends of the side members,
a head assembly including frame brackets which are fixed to the opposite sides of the frame near the second end of the frame, two handle brackets which are pivotably mounted to the frame brackets, the handle brackets slidably receiving the side members of the handle assembly, such that by pivoting movement of the handle brackets, the handle assembly is able to be pivoted between a first parallel position and a second right angle position and such that by sliding movement of the handle assembly, the handle assembly is able to be slid between a first retracted position and a second extended position, the head assembly further including a releasable lock mechanism for selectively locking and releasing the pivoting and sliding movement of the handle assembly, whereby, by selectively locking and releasing the lock mechanism and sliding and pivoting the handle assembly with respect to the frame, the handle assembly may be re-positioned with respect to the frame in various configurations including an upright configuration in which the handle assembly is parallel to the frame, a horizontal configuration in which the handle assembly is in the second extended position and pivoted into the second right angle position thereby supporting the frame in a horizontal position and an angled configuration in which the handle assembly is retracted and at an acute angle with respect to the frame so that the frame is supported in an inclined position,
the head assembly further including a lock mechanism having a housing that has a centerline that in the transverse direction, a push member and opposite shuttles that are connected at least indirectly to locking pins on both sides that govern the locking of the rotation of the handle and the sliding of the handle, the push member being constrained to move in a direction that is normal to the centerline of the housing and the shuttles being constrained to move in a direction that is aligned with the centerline, the shuttles and the push member having corresponding slanted surfaces that engage each other so that when the push member is pushed with manual force, the shuttles move inwardly toward the center of the housing with symmetrical movement.

2. A mechanism for manually actuating the symmetrical and simultaneously inward translation of spaced apart members, comprising:
a housing that slidably houses a push member and two opposite shuttles which are at least indirectly connected to the spaced apart members, the push member and the shuttles presenting to each other inwardly sloped corresponding surfaces so that when the push member is pushed with manual pressure, the inwardly sloped surfaces of the push member engage the correspondingly inwardly sloped surfaces of the shuttles so that the shuttles move inwardly in a simultaneous and symmetrical manner thereby causing the spaced apart members to move toward each other in a simultaneous and symmetrical manner.
